(19) United States
(12) Patent Application Publication
(10) Pub. No.: US 2010/0164215 A1
(43) Pub. Date: Jul. 1, 2010

(54) VEHICLE OCCUPANT RESTRAINT SYSTEM

(75) Inventor: Takuya Nezaki, Mizunami-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/639,482

(22) Filed: Dec. 16, 2009

(30) Foreign Application Priority Data
Dec. 26, 2008 (JP) JP2008-335041

(51) Int. Cl. B60R 22/00

(52) U.S. Cl. 280/808

(57) ABSTRACT

A four-point seat belt system includes: a pair of left and right lap belts respectively having one ends supported by a vehicle seat and coupled to coupling portions respectively provided at the other ends to restrain a hip of a occupant; a pair of left and right shoulder belts that correspond to the left and right lap belts respectively, that are coupled at respective lower end portions to the corresponding lap belts, and that are used to restrain an upper body of the occupant; a pair of right and left retractors retracting upper ends of the respective shoulder belts and applying urging force to the respective shoulder belts in a direction to retract the shoulder belts; and a pair of left and right shape retainers provided at respective coupled portions at which the shoulder belts are coupled to the corresponding lap belts to retain the shape of the lap belt.

### INCORPORATION BY REFERENCE

The disclosure of Japanese Patent Application No. 2008-335041 filed on Dec. 26, 2008 including the specification, drawings and abstract is incorporated herein by reference in its entirety.

### BACKGROUND OF THE INVENTION

1. Field of the Invention

The invention relates to a vehicle occupant restraint system that restrains an occupant, seated in a seat, to the seat at least in the event of a crash.

2. Description of the Related Art

There is known a seat belt that includes a pair of left and right lap retractors that retract left and right lap belts and a pair of left and right shoulder retractors that retract left and right shoulder belts, in which the retracting forces of the lap retractors are set to be larger than the retracting forces of the shoulder retractors (for example, see Japanese Patent Application Publication No. 2004-330975 (JP-A-2004-330975)). According to the JP-A-2004-330975, this configuration prevents the lap belts from being raised by the retracting forces of the shoulder belts.

However, in the above described existing technique, it is necessary to provide four retractors in total, so there is still room for improvement in terms of simplification of the configuration.

### SUMMARY OF THE INVENTION

The invention provides a vehicle occupant restraint system that retains a lap belt in a properly worn position with a simple configuration without using guide means.

A first aspect of the invention provides a vehicle occupant restraint system. The vehicle occupant restraint system includes: a pair of left and right lap belts that respectively have one ends supported by a vehicle seat or a vehicle body and that are coupled to each other via coupling portions provided at the other ends of the lap belts to restrain a hip of a seated occupant; a pair of left and right shoulder belts that correspond to the left and right lap belts respectively, that are coupled at respective lower end portions to portions of the corresponding lap belts, the portions being outside the corresponding coupling portions in a seat width direction, and that are used to restrain an upper body of the seated occupant; a pair of left and right retractors that correspond to the left and right shoulder belts respectively, that retract upper ends of the corresponding shoulder belts and apply urging force to the corresponding shoulder belts in a direction to retract the shoulder belts; and a pair of left and right shape retainers that correspond to the left and right lap belts respectively, and that are provided at respective coupled portions at which the shoulder belts are coupled to the corresponding lap belts to retain the shape of the lap belts.

In the vehicle occupant restraint system according to the first aspect, as the left and right lap belts are coupled by the coupling portions, the left and right lap belts are worn on the hip of the seated occupant and the pair of left and right shoulder belts that extend vertically between the lap belts and the retractor are worn on the upper body of the seated occupant. When the lap belts and the shoulder belts are worn, the retracting force of the retractor is applied to the coupled portions, at which the corresponding shoulder belts are coupled to the left and right lap belts, via the respective shoulder belts.

Here, in the vehicle occupant restraint system, the shape retainers are respectively provided at the coupled portions at which the shoulder belts are coupled to the lap belts. Thus, the shape of each lap belt is retained against the retracting force of the retractor. Thus, by providing each lap belt simply with the shape retainer, each lap belt is retained in a properly worn position to the seated occupant.

In this way, the vehicle occupant restraint system according to the first aspect is able to retain the lap belts in a properly worn position with a simple configuration.

In the vehicle occupant restraint system according to the aspect of the invention, each shape retainer may be a reinforcement member that is superimposed on each coupled portion, at which each of the shoulder belts is coupled to a corresponding one of the lap belts, and that has flexibility in a thickness direction of the lap belt.

With the vehicle occupant restraint system according to the above embodiment, by superimposing the reinforcement members at the coupled portions at which the shoulder belts are coupled to the lap belts, deformation of the lap belts in the width direction is restricted, and the shapes of the lap belts are retained against the retracting force of the retractor. In addition, the reinforcement members each have flexibility in the belt thickness direction. This ensures wearability to the occupant.

In the vehicle occupant restraint system according to the first aspect, each shape retainer may be provided over a range that includes the coupled portion, at which each of the shoulder belts is coupled to a corresponding one of the lap belts, and both sides of each lap belt with respect to the coupled portion in a longitudinal direction of the lap belt.

According to the above aspect, each shape retainer (reinforcement member) is provided on each side of the coupled portion, at which each of the shoulder belts is coupled to a corresponding one of the lap belts, in the longitudinal direction. This effectively suppresses deformation of the lap belts by the retracting force of the retractor.

In the above aspect, each shape retainer may be provided over a range that includes a lower end of a corresponding one of the shoulder belts.

According to the above aspect, each shape retainer (reinforcement member) extends to the lower end portion of a corresponding one of the shoulder belts to prevent a situation that an inverted T-shaped portion formed near the coupled portion at which each of the shoulder belts is coupled to a corresponding one of the lap belts is deformed by the retracting force of the retractor. By so doing, the lap belts are further effectively retained in a properly worn position.

In the vehicle occupant restraint system according to the first aspect, each shape retainer may be provided on a surface of a corresponding one of the lap belts, opposite to a surface that contacts the seated occupant.

According to the above aspect, each shape retainer (reinforcement member) is provided on a surface of the lap belt (shoulder belt) away from the occupant. Thus, it is possible to retain the lap belts in a properly worn position with the configuration that rarely influences belt wearing feeling of the seated occupant.

In the vehicle occupant restraint system according to the first aspect, at least one of the lap belts and the shoulder belts may have inflatable portions that inflate with supplied gas, and each shape retainer may be provided within a range in which the inflatable portion is not provided or within a range into which the inflatable portion does not expand.

According to the above aspect, for example, in the event of a predetermined situation, such as a crash of a vehicle, the inflatable portions are supplied with gas to inflate to thereby protect the seated occupant. With the vehicle occupant restraint system, each shape retainer is arranged at a portion at which no inflatable portion is provided or a non-inflatable portion, so deployment of each inflatable portion is ensured. Then, with the vehicle occupant restraint system, the lap belts are retained in a properly worn position as described above. Thus, the inflatable portions are also inflated at proper positions, and it is possible to exercise required occupant restraint performance.

As described above, the vehicle occupant restraint system according to the embodiment of the invention is able to retain the lap belts at proper positions with a simple configuration.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a front view that shows a four-point seat belt system according to a first embodiment of the invention;

FIG. 2 is a perspective view that shows a molded plate that constitutes the four-point seat belt system according to the first embodiment of the invention;

FIG. 3 is a front view that schematically shows a four-point air belt system according to a second embodiment of the invention;

FIG. 4 is a schematic cross-sectional view, taken perpendicularly to the longitudinal direction, of an inflatable portion that constitutes the four-point air belt system according to the second embodiment of the invention; and

FIG. 5 is a perspective view that shows a molded plate according to an alternative embodiment.

### DETAILED DESCRIPTION OF EMBODIMENTS

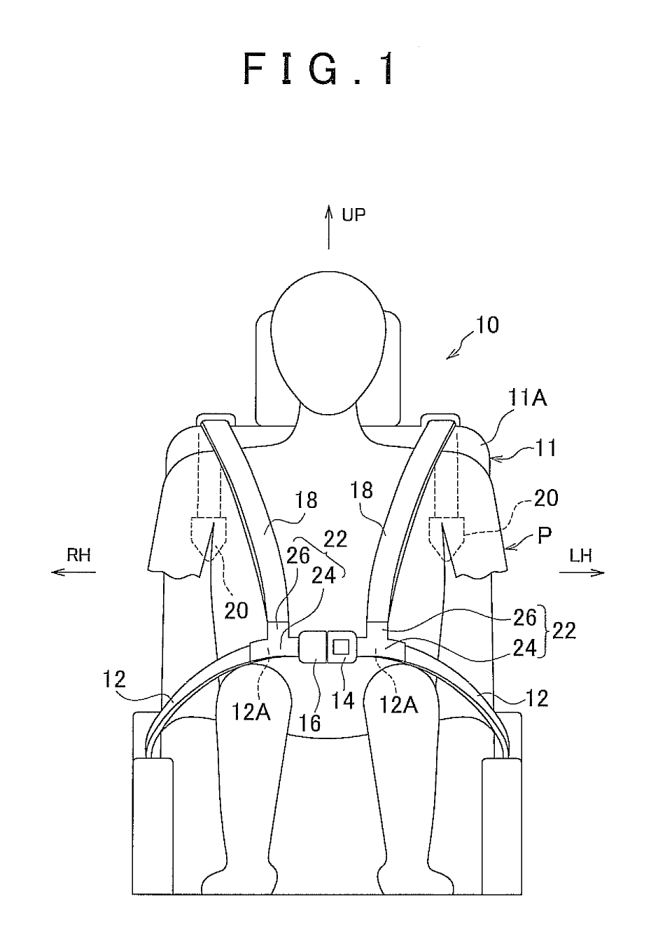

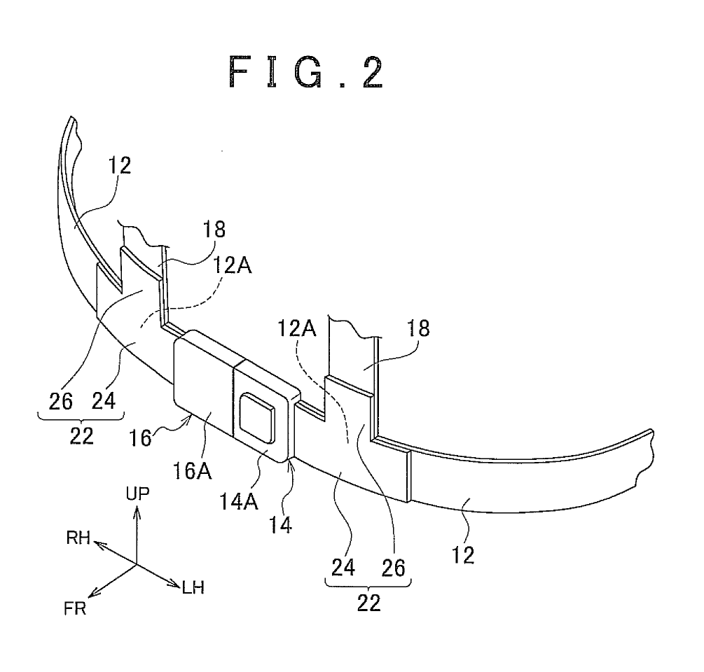

A four-point seat belt system 10, which is a vehicle occupant restraint system according to a first embodiment of the invention, will be described with reference to FIG. 1 to FIG. 2. Note that the arrow FR, the arrow UP, the arrow LH and the arrow RH in the drawings respectively indicate the forward direction (traveling direction), upward direction, and left and right sides (vehicle width direction) when directed in the traveling direction of a vehicle equipped with the four-point seat belt system 10. These substantially correspond to the forward direction, upward direction and left and right sides of a seat width direction of a vehicle seat 11 to which the four-point seat belt system 10 is applied.

FIG. 1 shows a schematic front view of a state where the four-point seat belt system 10 applied to the vehicle seat 11 is used (worn by an occupant). In addition, FIG. 2 shows a side view of the usage state where the four-point seat belt system 10 is used. In the following description, when a description is made with reference to the upper, lower, left and right directions, and the like, this usage state is used as a reference. As shown in FIG. 1, the four-point seat belt system 10 includes a pair of left and right lap belts 12. The outer end of each lap belt 12 in the seat width direction is coupled to the vehicle seat 11 or a vehicle body through an anchor member (not shown).

A buckle 14, which is an engaged member, is provided at the inner end of the left lap belt 12 in the seat width direction, and a tongue plate 16, which is an engaging member engageable with the buckle 14, is provided at the inner end of the right lap belt 12 in the seat width direction. As the tongue plate 16 is fastened to the buckle 14, the left and right lap belts 12 are worn on the hip (restrain the hip) of an occupant P seated on the vehicle seat 11. Therefore, the buckle 14 and the tongue plate 16 may function as coupling portions according to the invention.

In addition, the four-point seat belt system 10 includes a pair of left and right shoulder belts 18. The lower end portion of the left shoulder belt 18 is coupled to a portion of the left lap belt 12 close to the buckle 14 (coupled portion 12A). The upper end of the left shoulder belt 18 is retracted by a retractor 20 so that the left shoulder belt 18 can be pulled out. Similarly, the lower end portion of the right shoulder belt 18 is coupled to a portion of the right lap belt 12 close to the tongue plate 16. The upper end of the right shoulder belt 18 is retracted by the retractor 20 so that the right shoulder belt 18 can be pulled out.

Each retractor 20 applies predetermined retracting force (tension) to a corresponding one of the shoulder belts 18 to suppress a slack of the shoulder belts 18 worn by the occupant. In this embodiment, the retractors 20 are installed in a seat back 11A that constitutes the vehicle seat 11.

Thus, when the four-point seat belt system 10 is not used, the left lap belt 12 and the left shoulder belt 18 are placed along the left side portion of the seat back 11A, and the right lap belt 12 and the right shoulder belt 18 are placed along the right side portion of the seat back 11A (not illustrated in the drawing).

The four-point seat belt system 10 is configured so that, as the buckle 14 and the tongue plate 16 are coupled by the occupant P seated on the vehicle seat 11, the left and right lap belts 12 arranged in series with each other are worn on the hip of the occupant P seated on the vehicle seat 11, and the pair of left and right shoulder belts 18 arranged in parallel with each other are worn on the upper body of the seated occupant P.

In the present embodiment, a connecting portion at which the buckle 14 is connected to the left lap belt 12 is spaced at a predetermined distance away from a connecting portion at which the shoulder belt 18 is connected to the left lap belt 12. Similarly, a connecting portion at which the tongue plate 16 is connected to the right lap belt 12 is spaced at a predetermined distance away from a connecting portion at which the shoulder belt 18 is connected to the right lap belt 12.

Then, the four-point seat belt system 10 includes a pair of left and right molded plates 22 that function as shape retainers or reinforcement members. Each molded plate 22 is, for example, made of a resin material and is formed into a thin-plate shape having flexibility in the thickness direction. In this embodiment, each molded plate 22 has an inverted T shape in front view, and is fixed in a state where the molded plate 22 is superimposed on the corresponding lap belt 12 and shoulder belt 18 in the thickness direction.

Specifically, each molded plate 22 includes a lap fixing portion 24 and a shoulder fixing portion 26. The lap fixing portion 24 is fixed to both sides, in the longitudinal direction, of the coupled portion 12A at which each of the shoulder belts 18 is coupled to a corresponding one of the lap belts 12. The shoulder fixing portion 26 extends upward from a substantially middle portion, in the longitudinal direction, of the lap fixing portion 24 and is fixed to the lower end portion of the shoulder belt 18. In this embodiment, the lap fixing portion 24 has a substantially equal width to that of the lap belt 12, and the shoulder fixing portion 26 has a substantially equal width to that of the shoulder belt 18.

In addition, as shown in FIG. 2, each molded plate 22 is fixed to the front surface side, with respect to the vehicle, of the coupled portion 12A between the corresponding lap belt 12 and shoulder belt 18. That is, each molded plate 22 is fixed to the first surfaces of the lap belt 12 and shoulder belt 18. The first surfaces are opposite to the second surfaces of the lap belt 12 and the shoulder belt 18. The second surfaces contact the seated occupant P.

In this embodiment, one end of the lap fixing portion 24 in the left molded plate 22 extends to the buckle 14 and is integrated (for example, integrally molded or mechanically coupled) with a resin case 14A that constitutes the buckle 14. On the other hand, one end of the lap fixing portion 24 in the right molded plate 22 extends to the tongue plate 16 and is integrated (for example, integrally molded or mechanically coupled) with a resin cover 16A that constitutes the tongue plate 16.

Next, the operation of the first embodiment will be described.

In the above configured four-point seat belt system 10, as the occupant P seated on the vehicle seat 11 pulls out the shoulder belts 18 from the shoulder retractors 20 while engaging the tongue plate 16 with the buckle 14, the pair of left and right parallel shoulder belts 18 restrain the upper body of the occupant P seated on the vehicle seat 11, and the pair of left and right integrated (serial) lap belts 12 restrain the hip of the seated occupant P, as schematically shown in FIG. 1. Then, the molded plate 22 having flexibility in the thickness direction appropriately deforms depending on the body size of the occupant P seated on the vehicle seat 11.

When the lap belts 12 and the shoulder belts 18 are worn by the occupant

P, the retracting forces of the retractors 20 are applied to the coupled portions 12A at which the shoulder belts 18 are coupled to the left and right lap belts 12.

Here, in the four-point seat belt system 10, the molded plate 22 is provided at each coupled portion 12A at which each of the shoulder belts 18 is coupled to a corresponding one of the lap belts 12. This suppresses deformation, such as bending, of each lap belt 12 at the coupled portion 12A, at which each of the shoulder belts 18 is coupled to a corresponding one of the lap belts 12, due to the retracting force of the retractor 20.

Particularly, the lap fixing portion 24 of the molded plate 22 is not only provided at the coupled portion 12A but also provided over a range including both sides of the coupled portion 12A (which means that a support span is long). This effectively suppresses bending deformation at the coupled portion 12A. In addition, the molded plate 22 has the shoulder fixing portion 26 that extends to the lower end portion of the shoulder belt 18, so bending deformation at the coupled portion 12A is further effectively suppressed.

Thus, the four-point seat belt system 10 prevents or effectively suppresses each lap belt 12 from bending and deforming to ride up at the coupled portion 12A, at which each of the shoulder belts 18 is coupled to a corresponding one of the lap belts 12, because of the retracting force of the retractor 20. That is, each lap belt 12 is retained in a properly worn position.

In this way, the four-point seat belt system 10 according to the first embodiment is able to retain the lap belts 12 in a properly worn position with a simple configuration. That is, in the four-point seat belt system 10, without a complex configuration that, for example, retractors that respectively retract the outer ends of the left and right lap belts 12 in the seat width direction are provided and then the retracting forces of these retractors are made stronger than the retracting forces of the retractors 20, it is possible to retain the lap belts 12 in a properly worn position.

In addition, in the four-point seat belt system 10, each molded plate 22 has flexibility in the thickness direction. This can ensure wearability to the occupant P seated on the vehicle seat 11 while retaining the lap belts 12 in a properly worn position as described above. Moreover, each molded plate 22 is provided on the surfaces of the lap belt 12 and shoulder belt 18 away from the occupant, so the occupant P seated on the vehicle seat 11 may wear the belts with receiving little or no influence (uncomfortable feeling, or the like) on wearing feeling.

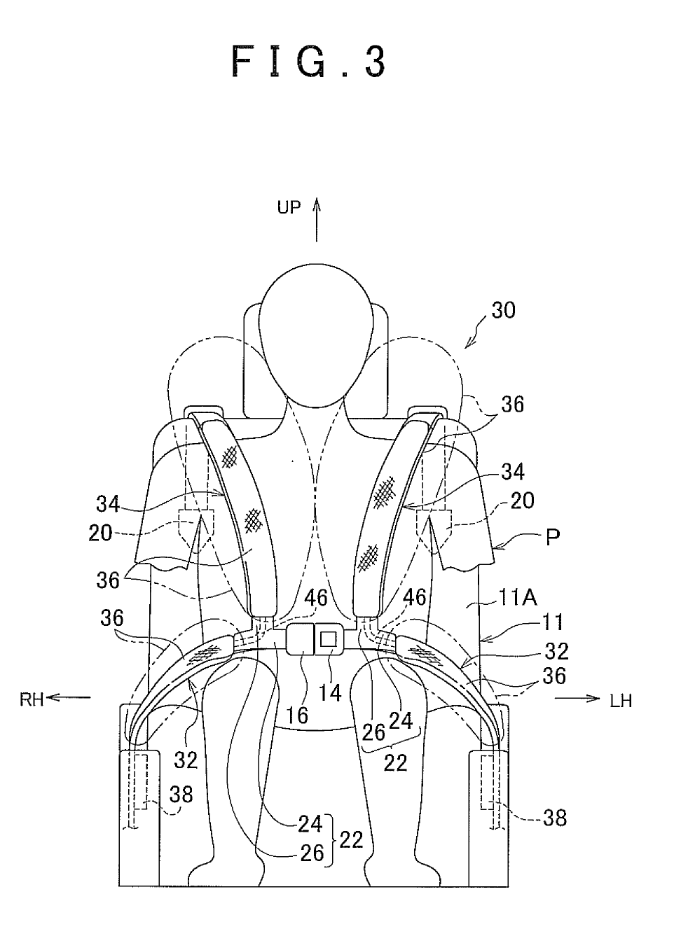

FIG. 3 shows a schematic front view of a four-point air belt system 30, which is a vehicle occupant restraint system according to a second embodiment of the invention. As shown in the drawing, the four-point air belt system 30 differs from the four-point seat belt system 10 according to the first embodiment in that lap belts 32 and shoulder belts 34 are provided instead of the lap belts 12 and the shoulder belts 18 and portions of the lap belts 32 and shoulder belts 34 in the longitudinal direction thereof have inflatable portions 36.

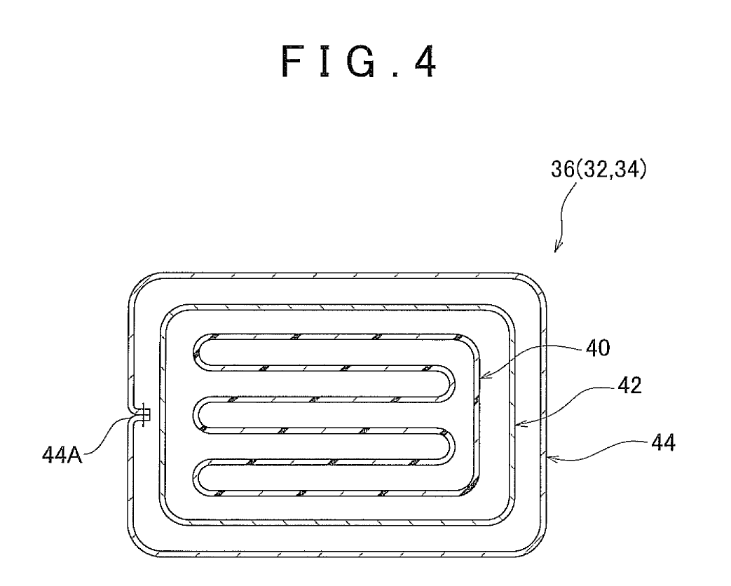

As shown in FIG. 4, each inflatable portion 36 includes an airbag 40, a mesh webbing 42 and a cover 44 as major components. The airbag 40 inflates and deploys into a predetermined shape (see the imaginary line shown in FIG. 3) with gas supplied from an inflator 38. The mesh webbing 42 is formed as an extensible bag so as to cover the airbag 40. The cover 44 breaks at a tear portion 44A as the mesh webbing 42 accommodated therein inflates as the airbag 40 inflates. Each inflatable portion 36 is connected to portions of the lap belt 32 and shoulder belt 34, other than the inflatable portion 36, (portions formed of non-inflatable belt-like webbings) by the mesh webbing 42.

In the present embodiment, the airbag 40 of the inflatable portion 36 of the lap belt 32 and the airbag 40 of the inflatable portion 36 of the shoulder belt 34, located on the same side as the above lap belt 32, are in fluid communication with each other through a communication passage 46 (see FIG. 3). Each communication passage 46 is, for example, formed of a non-inflatable portion or a flexible tube formed integrally between the airbags 40 on the same side.

Then, in the four-point air belt system 30, each molded plate 22 is determined to have dimensions and shape so as to be fixed within a range of the lap belt 32 and shoulder belt 34, in which the airbag 40 is not installed. In this embodiment, the communication passages 46 extend through the regions, in which the molded plates 22 are installed, on the left and right lap belts 32 and shoulder belts 34 to provide fluid communication between the airbags 40 (inflatable portions 36) that are spaced apart vertically as described above.

Then, the four-point air belt system 30 is configured so that, as an ECU (not shown) activates the inflators 38, the inflatable portions 36 of the left and right lap belts 32 and shoulder belts 34 are inflated and deployed into a predetermined shape as indicated by the imaginary line in FIG. 3. The ECU is configured to activate the inflators 38 when a collision of the vehicle is detected or predicted on the basis of a signal from collision monitoring means, such as a crash sensor and a millimeter-wave radar. Thus, the four-point air belt system 30 is configured to protect the occupant P seated on the vehicle seat 11 by deploying the inflatable portions 36 in the event of a vehicle collision. In addition, the other configuration of the four-point air belt system 30 is similar to the corresponding configuration of the four-point seat belt system 10 including portions not shown in the drawing.

Thus, the four-point air belt system 30 according to the second embodiment basically can obtain a similar advantageous effect to that of the four-point seat belt system 10. In addition, in the four-point air belt system 30, the lap belts 32 are retained in proper positions by the respective molded plates 22 to retain the inflatable portions 36 of the shoulder belts 34 in proper positions. Thus, occupant restraint performance is ensured (improved) by the shoulder belts 34, which are the air belts, equipped with the inflatable portions 36. Furthermore, the molded plates 22 provided at portions, into which the inflatable portion 36 does not expand, do not influence deployment of the inflatable portions 36. This also contributes to ensuring occupant restraint performance by the shoulder belts 34 equipped with the inflatable portions 36.

Note that the second embodiment describes an example in which each inflatable portion 36 is provided for each of the lap belt 32 and the shoulder belt 34; however, the aspect of the invention is not limited to this embodiment. For example, it is also applicable that each inflatable portion 36 is provided only for any one of the lap belt 32 and the shoulder belt 34.

In addition, the second embodiment describes an example in which the inflatable portion 36 of the lap belt 32 and the inflatable portion 36 of the shoulder belt 34, located on the same side as the lap belt 32, are supplied with gas from the common inflator 38; however, the aspect of the invention is not limited to the embodiment. For example, it is also applicable that each inflatable portion 36 is supplied with gas from an exclusive inflator.

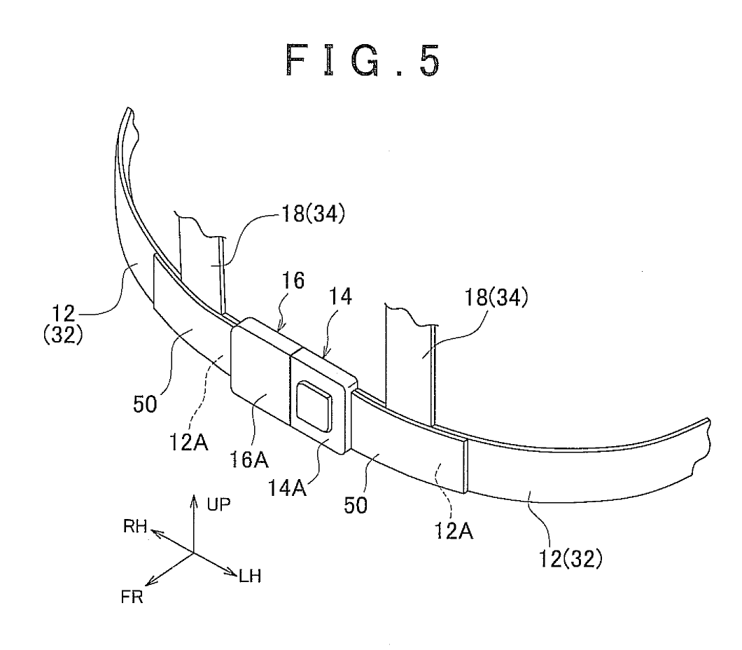

Furthermore, the above embodiments describe an example in which the substantially inverted T-shaped molded plates 22 are used; however, the aspect of the invention is not limited. For example, it is also applicable that, as shown in FIG. 5, rectangular molded plates 50 that are only fixed to the lap belts 12 or 32 are used. Each molded plate 50 is formed similarly to the lap fixing portion 24 of the molded plate 22.

Furthermore, the above embodiments describe an example in which the lap fixing portion 24 and shoulder fixing portion 26 of each molded plate 22 respectively have substantially equal widths to those of the lap belt 12 and the shoulder belt 18; however, the aspect of the invention is not limited to this configuration. For example, it is also applicable that a molded plate having a width narrower than those of the lap belt 12 and shoulder belt 18 (lap belt 32 and shoulder belt 34) is used.

In addition, the above embodiments describe an example in which the molded plate 22 or 50 is made of a resin material having a rigidity larger than that of the lap belt; however, the aspect of the invention is not limited to this configuration. For example, it is also applicable that a webbing having the same material is superimposed on the lap belt 12 to form a shape retainer or a thick portion (including a thickened coating material, or the like) is partially formed on the lap belt 12 to form a shape retainer.

Furthermore, the above embodiments describe an example in which the outer end of each lap belt 12 or lap belt 32 in the vehicle width direction is coupled to the vehicle seat 11 or the vehicle body via an anchor; however, the aspect of the invention is not limited to this configuration. For example, it is also applicable that the outer end of each lap belt 12 or lap belt 32 in the vehicle width direction is retracted by a retractor. In this case as well, no restrictions, such as limitations on retracting force due to the relationship with the retractor 20, is imposed on the retractor of each lap belt 12 or lap belt 32, so it is possible to simplify the structure of the vehicle occupant restraint system as a whole.

What is claimed is:

1. A vehicle occupant restraint system comprising:
a pair of left and right lap belts that respectively have one ends supported by a vehicle seat or a vehicle body and that are coupled to each other via coupling portions provided at the other ends of the lap belts to restrain a hip of a seated occupant;
a pair of left and right shoulder belts that correspond to the left and right lap belts respectively, that are coupled at respective lower end portions to portions of the corresponding lap belts, the portions being outside the corresponding coupling portions in a seat width direction, and that are used to restrain an upper body of the seated occupant;
a pair of left and right retractors that correspond to the left and right shoulder belts respectively, that retract upper ends of the corresponding shoulder belts and that apply urging force to the corresponding shoulder belts in a direction to retract the shoulder belts; and
a pair of left and right shape retainers that correspond to the left and right lap belts respectively, and that are provided at respective coupled portions at which the shoulder belts are coupled to the corresponding lap belts to retain the shape of the lap belts.

2. The vehicle occupant restraint system according to claim 1, wherein
each shape retainer is a reinforcement member that is superimposed on each coupled portion, at which each of the shoulder belts is coupled to a corresponding one of the lap belts, and that has flexibility in a thickness direction of the lap belt.

3. The vehicle occupant restraint system according to claim 2, wherein
each reinforcement member is made of a material having a rigidity larger than that of each lap belt.

4. The vehicle occupant restraint system according to claim 2, wherein
each reinforcement member is a thin plate and is superimposed on each lap belt in the thickness direction of the lap belt.

5. The vehicle occupant restraint system according to claim 4, wherein
one end of each reinforcement member is integrated with the coupling portion located adjacent to that reinforcement member.

6. The vehicle occupant restraint system according to claim 1, wherein
each shape retainer is provided over a range that includes the coupled portion, at which each of the shoulder belts is coupled to a corresponding one of the lap belts, and both sides of each lap belt with respect to the coupled portion in a longitudinal direction of the lap belt.

7. The vehicle occupant restraint system according to claim 6, wherein
each shape retainer is provided over a range that includes a lower end of a corresponding one of the shoulder belts.

8. The vehicle occupant restraint system according to claim 7, wherein
each shape retainer is a thin plate that has an inverted T shape in front view.

9. The vehicle occupant restraint system according to claim 1, wherein
each shape retainer is provided on a surface of a corresponding one of the lap belts, opposite to a surface that contacts the seated occupant.

10. The vehicle occupant restraint system according to claim 1, wherein
at least one of the lap belts and the shoulder belts have inflatable portions that inflate with supplied gas, and each shape retainer is provided within a range in which the inflatable portion is not provided or within a range into which the inflatable portion does not expand.
